(19) United States
(12) Patent Application Publication
(10) Pub. No.: US 2003/0151352 A1
(43) Pub. Date: Aug. 14, 2003

(54) Field emitting apparatus and method

(75) Inventor: Sataro Yamaguchi, Aichi (JP)

Correspondence Address: SUGHRUE MION, PLLC, 2100 Pennsylvania Avenue, NW, Washington, DC, 20037-3213, US

(73) Assignee: KABUSHIKI KAISHA Y.Y.L.

(21) Appl. No.: 10/335,857

(22) Filed: Jan. 3, 2003

(30) Foreign Application Priority Data
Jan. 15, 2002 (JP) 2002-005727

(51) Int. Cl. H01J 1/62

(52) U.S. Cl. 313/495; 313/310

(57) ABSTRACT

An apparatus and method which enhances the electron emission efficiency in a field emission apparatus having carbon nanotube(s) in a cathode as an electron emitting material. In a field emission apparatus having carbonanotube(s) as an electron emitting material on a cathode 2, the electron emission efficiency from the carbon nanotube(s) 1 is enhanced by irradiating carbon nanotubes 1 with infrared light.

### FIELD OF THE INVENTION

The present invention relates to a field emission technology using carbon nanotubes and in particular to an apparatus and method for enhancing the electron emission strength.

### BACKGROUND OF THE INVENTION

Carbon nanotubes (also referred to as “CNT”) have a structure in which a sheet of graphite is enrolled into a cylindrical shape. A carbon nanotube which comprises a single layer is referred to as a single wall CNT (SWNT) whereas a carbon nanotube which comprises a number of telescopic layers is referred to as a multi-wall CNT (MWNT). The carbon nanotube is capable of conducting a high current therethrough, will not melt unlike metals, and is stable in atmosphere and is excellent in heat dissipation due to its high heat conductivity.

As the application of the carbon nanotubes, efforts of development and commercialization into products such as probes for scanning probe type microscopes and field emission display (FED) have been made. The products to which the carbon nanotubes are applied take an advantage of their characteristics in which electrons are readily emitted from the tip(s) of the carbon nanotube(s) under the influence of an electric field due to the fact that the carbon nanotubes are thin and elongated and have a high electric conductivity.

Prior to description of the invention, field emission is briefly explained. Considering the energy of electrons in the vicinity of the surface of a metal in vacuum, the potential energy of electrons in the metal at room temperatures is lower than the Fermi-level and is lower than the energy in vacuum external of the metal. Accordingly, electrons will not jump beyond their potential barrier (work function φ). When a metal is heated, electrons in the metal are excited, and many of the electrons have an energy level which is higher than that of the work function, so that thermal electron emission in which electrons are emitted into vacuum space occurs. The electron density of the thermal electron emission is represented by J=AT²exp(−W/kT) wherein k is Boltzmann constant and T is absolute temperature. This is the principle of vacuum tube.

When a high electric field F is applied to the surface of a metal, the potential energy in vacuum is represented by a sum V of an effect due to the electric field and an effect of mirror image force of the electrons. As the electric field increases the potential barrier decreases by an amount of Schottokey effect. Some of the electrons which are in the vicinity of the Fermi-level are emitted at a probability due to tunnel effect, so that field emission takes place. The current density of the field emission is represented by J=AV²exp(−B/V). Since an electron gun using the field electron emission has a high emission current density and emits electrons which are uniform in energy, so that a high brightness is provided. For more information on the field emission, refer to a reference, such as A. Modnos, “Theoretical analysis of field emission data”, Solid-State Electronics, 45 (2001) 809-816, the contents thereof being incorporated herein by reference thereto.

In order to cause electrons to emit from a highly oriented (CNT film, it is known to conduct a structure control by heat-treating CNT formed on an SiC monocrystal wafer. A FED using CNT has a cathode on which a CNT film is applied, wherein electrons emitted from CNT via a grid electrode are accelerated toward an anode electrode so that they impinge upon a fluorescent material for emitting light therefrom. A result of total current of 240 μA etc. is obtained under conditions, e.g., that a CNT film of 3×3 mm; a distance of 0.5 mm between the grid electrode and the CNT film; a threshold of field emission of 1.5 v/μm; and a field strength of 3V/μm. For further information of FED, refer to the description of a reference “Masaki ITO et al, “Application of highly oriented carbon nanotube film to electron source”, Material Integration, No. 1, Vol. 15, 43-47, January 2002 published by TIC, the contents thereof being incorporated herein by reference thereto.

As for the principle of the field emission from carbon nanotubes, refer to a reference (W. Zhu et al, “Electron field emission from nanostructured diamond and carbon nanotubes”, Solid-State Electronics, 45 (2001) 921-928, and “Field emission from carbon nanotubes: the first five years”, J.-M. Bonard et al, Solid-State Electronics, 45 (2001) 893-914, the contents thereof being incorporated herein by reference thereto.

As for the relation between the field emission current and the electric field, refer to a reference Jean-marc Bonard et al., “Field emission from carbon nanotubes: the first five years”, Solid-State Electronics, 45 (2001) 831-914. This reference reports that current density Jmax of 10 A/cm², 0.1 A/cm², 4 A/cm² and 0.1 to 1 A/cm² were obtained at electric field of 15 V/μm, 20 V/μm, 4 to 7 V/μm and 6.5 V/μm by using MWNT, arc MWNT, SWNT and CVDMWNT (multi-layered CNT manufactured by CVD), respectively.

For example, JP-P2000-164112A discloses a structure in which efficient electron emission is achieved by heating with a heater carbon nanotubes which are electron emitting material of a vacuum cathode for causing the electrons to be thermally emitted in a vacuum vessel or further simultaneously applying an electric field to an anode to cause thermal field emission of electrons, in order to cause efficient emission of electrons by applying a voltage as low as possible (low electric field strength) and to conduct stable current control in a vacuum cathode made of carbon nanotubes as an electron emitting material.

### SUMMARY OF THE DISCLOSURE

There is much to be desired in the conventional art.

Therefore, it is an object which is to be accomplished by the invention to provide an apparatus and method of enhancing the emission efficiency of electrons in a field emission apparatus having a cathode comprising carbon nanotube or nanotubes as an electron emitting material.

In order to accomplish the above-mentioned object, there is provided in a first aspect of the present invention a field emitting apparatus comprising a cathode provided with carbon nanotube(s) (i.e., at least one nanotube) as an electron emitting material, comprising means for irradiating said carbon nanotube(s) with light.

The apparatus of the present invention further comprises a polarizer, e.g., means for polarizing light to irradiate the carbon nanotubes with the light having an electric field oriented along a longitudinal axial direction of the carbon nanotube(s).

In the apparatus of the present invention, the polarizer, the means for polarizing the light comprises a thin film having an anisotropy in electric conductivity, the thin film having an electric conductivity along the longitudinal axial direction of the carbon nanotube(s) in place of the thin film and having no electric conductivity along a direction normal to the longitudinal axial direction, the thin film being irradiated with the light for polarizing the light.

In the apparatus of the present invention, the light comprises infrared light. In the apparatus of the present invention, the light comprises laser light. In the apparatus of the present invention, the carbon nanotube (s) has/have a length which is about a half of a spot area of the laser light.

In another aspect of the present invention, in a method of field emitting electrons by applying electric field to a cathode formed of carbon nanotube(s), the carbon nanotube(s) is/are irradiated with light for enhancing emission efficiency of electrons. In the method of the present invention, the light which irradiates the carbon nanotube(s) has its electric field which is parallel with a longitudinal axial direction of the carbon nanotube(s).

In a further aspect, there is provided a field emitting apparatus comprising: a cathode provided with at least one carbon nanotube as an electron emitting material, means for irradiating said at least one carbon nanotube with light, and means for accelerating electrons emitted from the cathode along said at least one carbon nanotube.

In a still further aspect, there is provided a method for field emitting electrons comprising: applying an electric field to said cathode, providing a cathode provided with at least one carbon nanotube, irradiating said carbon nanotubes with light for enhancing emission efficiency of electrons, and accelerating electrons emitted from the cathode along said at least one carbon nanotube.

### BRIEF DESCRIPTION OF THE DRAWINGS

FIG. 1 is a diagram explaining a structure of one embodiment of the present invention.

FIG. 2 is a view explaining the principle of the present invention.

FIG. 3 is a view explaining the principle of the present invention according to an embodiment.

FIG. 4 is a view explaining the present invention;

FIG. 4(A) is a view explaining an embodiment of a process for manufacturing a polarizer and FIG. 4(B) is a view explaining this principle of the polarizer.

FIG. 5 is a view explaining the principle of the invention; FIG. 5(A) is a view explaining the principle for generating plasma by irradiating an antenna (rod) with electromagnetic wave and FIG. 5(B) is a view explaining the principle of a dipole antenna.

FIG. 6 is a view explaining the principle of the present invention.

FIG. 7 is a graph showing a result of calculation of the acceleration of electron in the present invention.

### PREFERRED EMBODIMENTS OF THE INVENTION

Modes of embodying the present invention are described. In one mode of embodying the present invention, carbon nanotube(s) is/are preferably irradiated with ultrared light in a field emission apparatus which has carbon nanotube(s) (at least one nanotube) at or in a cathode as an electron emitting material. In the present invention, the carbon nanotube(s) is/are irradiated with ultrared light which is polarized has its electric field in parallel with a longitudinal axis of the carbon nanotube(s) for accelerating electrons along the carbon nanotube(s). A voltage is applied between the carbon nanotube(s) provided in association with a cathode and an electrode (anode or grid) which forms an anode for enhancing the efficiency of field emission of electrons. The carbon nanotube may be part of the cathode or disposed separate from the cathode in the vicinity thereof.

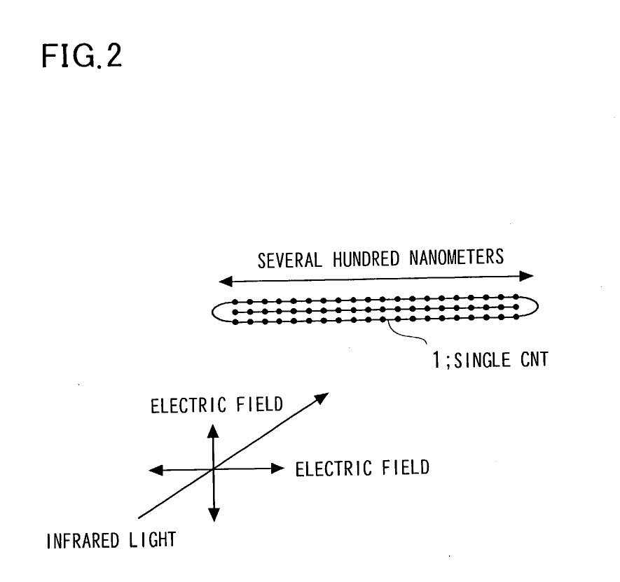

The principle of the present invention will now be described with reference to FIG. 2. An experiment of carbon nanotube (also referred to as “CNT”) which was carried out by Dresselhaus Group is briefly described.

In the experiment, infrared light is absorbed by one CNT having a length of several hundred nanometers (nm). Absorption of light depends upon the polarization of light and the arrangement (disposition) of CNT.

If the electric field of light is parallel with the longitudinal axis of CNT, the absorption of light is high. If the electric field of light is normal to the longitudinal axis of CNT, the absorption of light is low. If CNT is used as a cathode (or disposed in the vicinity of cathode) for emitting electrons in the present invention, the electric field of the light which is incident upon CNT is oriented parallel with the longitudinal axis of CNT for enhancing the light absorption. This increases the emission efficiency of electrons which are emitted from the tip of CNT under influence of an electric field in the longitudinal axial direction. The length of CNT may be about one half of a wave length of the ultrared light for exposure (e.g., an electromagnetic wave having a wave length of about 0.76 μm to about 1 mm).

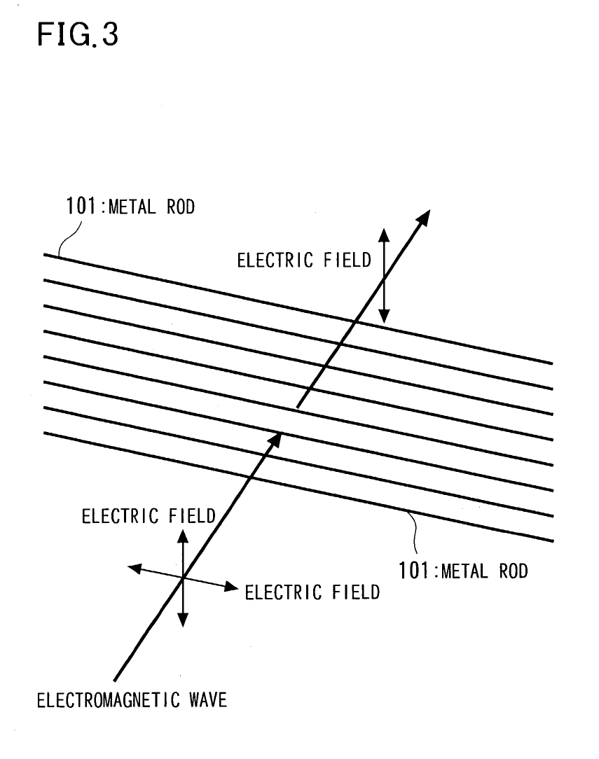

Now, transmission of the electromagnetic wave is briefly described with reference to FIG. 3. A plurality of metallic rods 101 are disposed in a parallel and spaced relationship. The distance between the neighboring rods is shorter than the wave length of the electromagnetic wave. The rods have a length which is longer than the wave length of the electromagnetic wave. The parallely disposed rods permit the electromagnetic wave component having electric field normal to the longitudinal direction of the rods (“normal component” of the wave) to pass therethrough and to shield an electromagnetic wave component having electric field which is parallel with the longitudinal direction of the rods (i.e., “parallel component” of the wave). In such a manner, the plurality of rods 101 which are disposed in a parallel relationship constitute a polarizer.

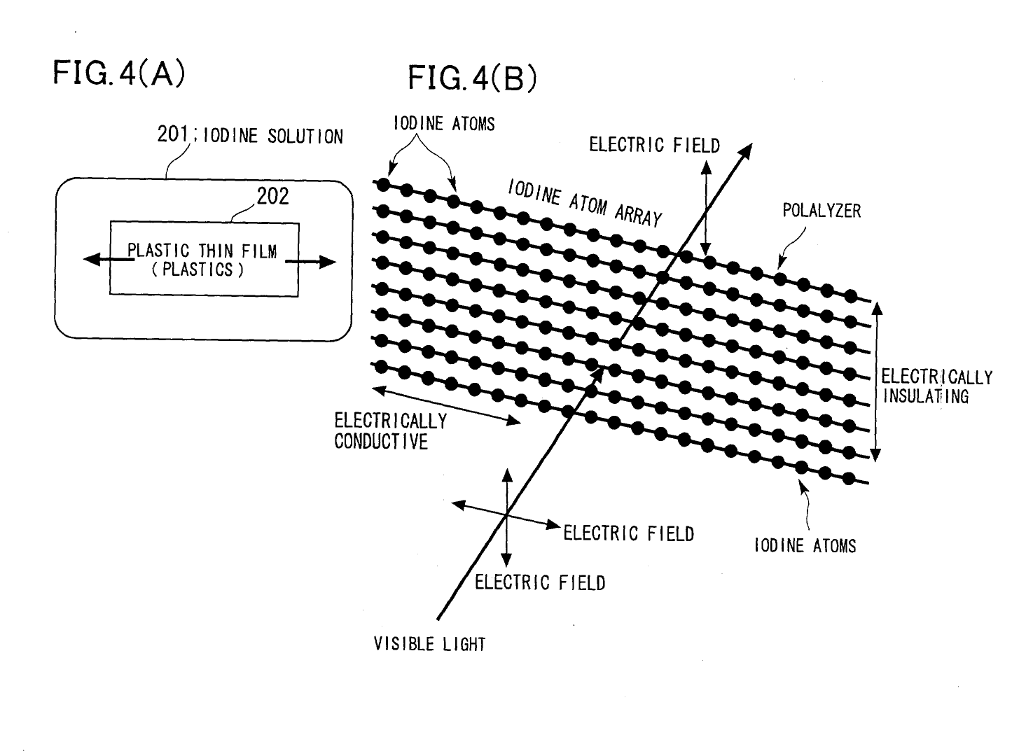

Now, an exemplary polarizer for visible light will be described with reference to FIG. 4. As shown in FIG. 4(A), a thin film of a plastic resin capable of absorbing iodine or like ions or atoms 202 is immersed in an iodine solution 201. The resin may be, e.g., PVA, while ions may be of iodide, e.g., potassium iodide or dye. When the film 202 is pulled at the opposite ends thereof in opposite directions as denoted by arrows, iodine atoms are absorbed generally as polyiodine ions in the thin film of a uniaxially expanded plastic resin, so that they are aligned in pulling directions as shown in FIG. 4(B). A thin film having an electric conductivity in pulling directions and an electric insulation in directions normal to the pulling direction in place thereof (anisotropic conductivity) in which the distance between the iodine atoms is short is manufactured. The film enables the visible light having passed therethrough to be polarized. In other words, the film acts as a polarizer for visible light. The polarizing film is usually laminated with a support film e.g., triacetate film. Reference is made to articles (i), (ii) and (iii) as follows:

(i) E. Takamiya, et al: J. App I. Poiym. Sci., Vol. 50 P. 1807 (1993)

(ii) H. Takamiya, et al: Pepts. Pfogr. Polym. Phys. Japan, Vol. 33 p. 225 (1990)

(iii) Y. Oishi, et al: Polym. J., Vol. 19 p. 225 (1990); the entire disclosure thereof being incorporated herewith by reference thereto.

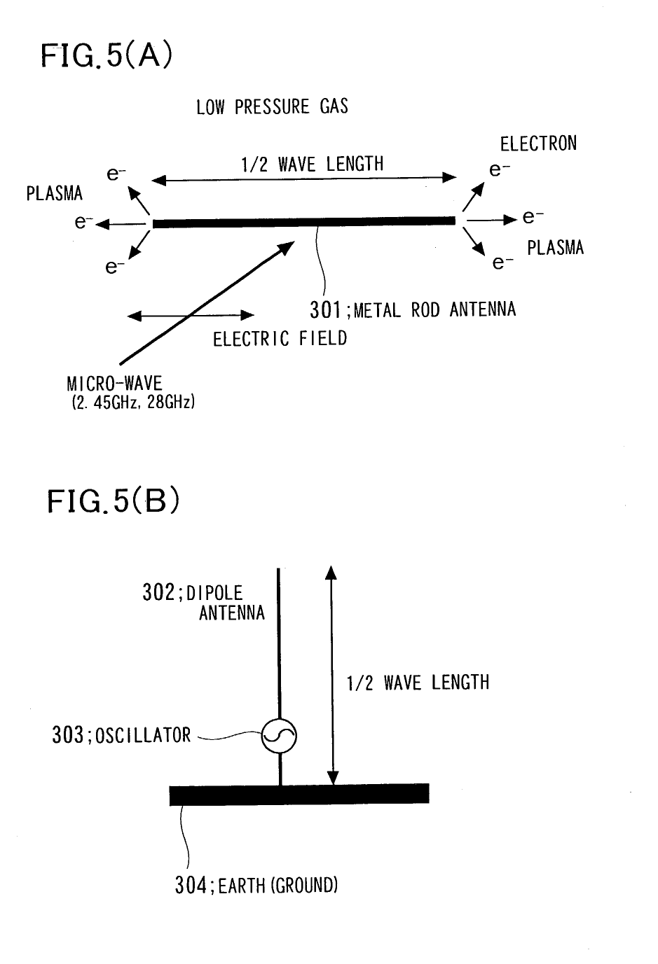

Now, a process for generating a plasma by irradiating a conductive member with electromagnetic wave is described with reference to FIG. 5. A metal rod/antenna 301 is placed in a low pressure gas as shown in FIG. 5(A). Micro-wave (2.45 GHz, 28 GHz) is irradiated into an evacuated space. The electric field of the injected micro-wave is parallel with a longitudinal axial direction of the metal rod/antenna 301. The metal rod/antenna 301 has a length which is about one half of that of the wave length of the electromagnetic wave. Since the length of the metal rod/antenna 301 is one half of the wave length, the electric field in a direction of FIG. 5(A) assumes a positive value for (a first) one half of a period (corresponding to one end to the other end of the metal rod/antenna 301 in a longitudinal direction thereof) and assumes a negative value for a next half of the period. Accordingly, electrons (e⁻) are accelerated in a direction from the left to the right as viewed in the drawing in the positive electric field within the metal rod/antenna 301 of FIG. 5(A) for the first half period, and then accelerated in a direction from the right to the left in the negative electric field within the metal rod/antenna 301 for the next half period. Thus, the electrons which have been accelerated within the metal rod/antenna 301 in right and left longitudinal directions under the influence of the electric field of the micro-wave are emitted from the opposite ends of the metal rod/antenna 301, to form a plasma (electron gas). In the present invention, a cathode is provided with a metal rod/antenna 301 having a length equivalent to one half of the wave length of the radiating micro-wave as an electron emitting material. One end of the metal rod/antenna 301 is an open end (the other end is connected to a cathode portion). The electric field of the micro-wave with which the metal rod/antenna 301 is irradiated is parallel with the longitudinal axis of the metal rod/antenna 301. Electrons are emitted from the open ends of metal rod/antenna 301. It can be said that this electron emission phenomenon be similar to the electromagnetic wave radiation from a dipole antenna (comprising an antenna 302 and oscillator 303). The length of the metal rod/antenna 301 may be about one third to about three quarters of the wave length of the electromagnetic wave.

The present invention contemplates to enhance the efficiency of the field emission of electrons by assuming carbon nanotube (s) as a rod antenna as shown in FIG. 2 for emitting accelerated electrons as will be described hereafter.

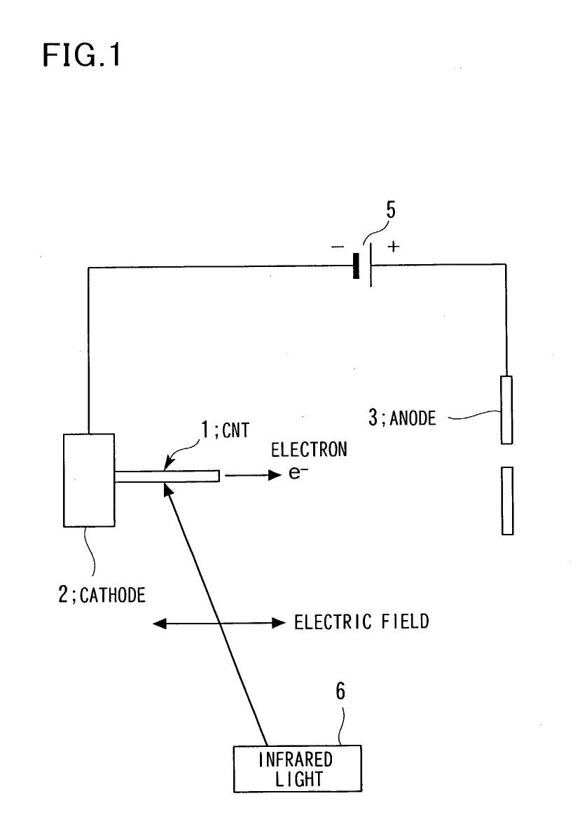

Embodiments of the present invention are described. FIG. 1 is a schematic diagram showing the structure of one embodiment of the present invention. A voltage is applied to an anode electrode 3 which is connected to a power source 5 and a carbon nanotube 1 of a cathode portion 2 is irradiated with ultrared rays from an ultrared light emitting unit 6, so that the emission efficiency of electrons (e⁻) from the carbon nanotube 1 is enhanced. As schematically shown in FIG. 1, in one embodiment of the present invention the electric field of the ultrared rays is made (palarized) parallel with the longitudinal axis of the carbon nanotube 1 via the above-mentioned polarizer. The ultrared light emitting unit 6 includes the polarizer which has been described with reference to FIG. 4. The electric field of the ultrared rays is made (polarized) parallel with the longitudinal axis 1 via the above-mentioned polarizer.

It is of course that a grid electrode may be provided between the carbon nanotube 1 and the anode 3. An FED (Field Emission Display) can be formed by providing a fluorescent material (not shown) on one side of the anode opposite to the carbon nanotube 1. In this display, electrons which have passed through a void (slit or aperture) of the anode 3 will impinge upon the fluorescent material to emit light therefrom. The carbon nanotube 1, cathode portion 2, anode 3 and fluorescent material are hermetically sealed in an evacuated space in an enclosure (vessel).

The structure of one rod made of a single-layer CNT which forms an electron gun is shown in FIG. 1. It is of course that the electron gun may include a multiplicity of rods made of a multiplicity of CNTs formed in alignment each other on, for example, SiC mono-crystal.

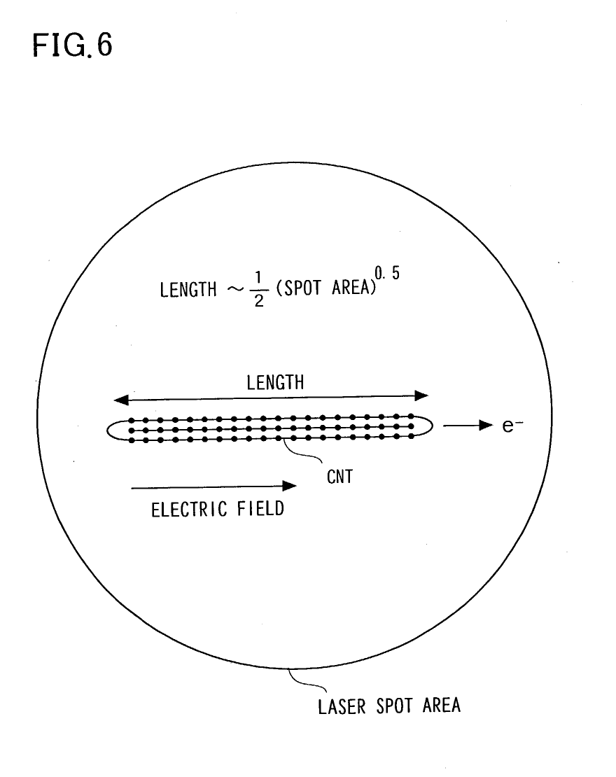

Now, acceleration of electrons by the electromagnetic wave is described with reference to FIG. 6. In this example, a carbon nanotube (CNT) is irradiated with laser light to accelerate electrons in the CNT. At a laser spot area which is schematically shown in FIG. 6, the electromagnetic wave is made parallel with the longitudinal axis of CNT and the length of CNT is about one half of the square root of the spot area of the laser light (½ (spot area)^{0.5}).

Assume that pointing vector N consisting of an area electric field E and an area magnetic field H, and a spot area S is represented as N (N=E×H), a relationship P/S=N where P denotes a laser power is established. Therefore, the energy gain of an electron is represented as follows:

(2/π)ES^{0.5}

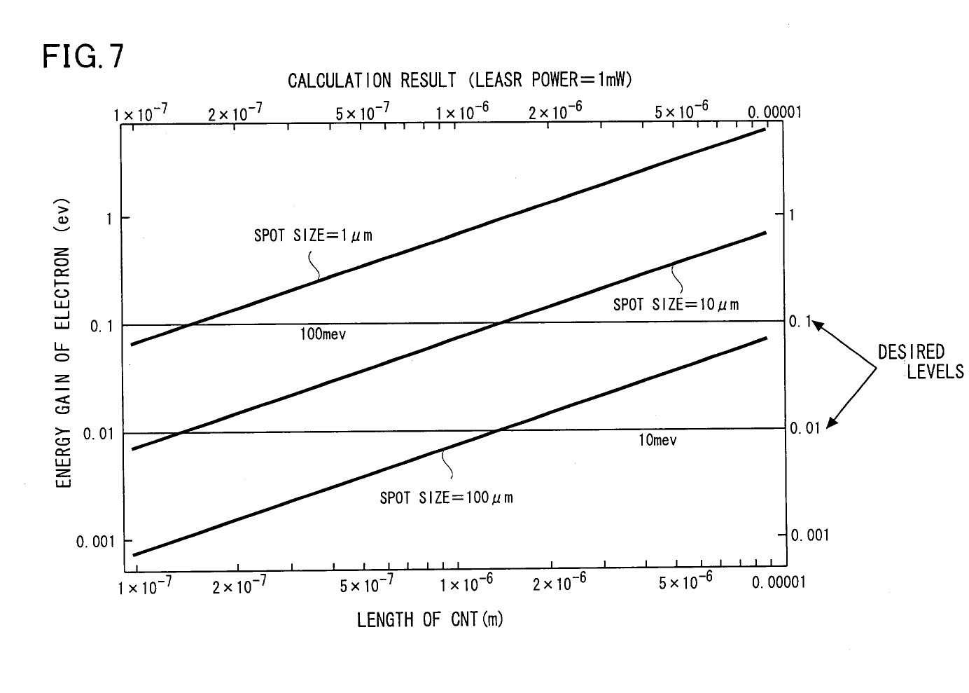

FIG. 7 is a graph showing a result of calculation of the acceleration of an electron, which is conducted by electromagnetic wave in which parameters are the sPot size of the laser versus the length of CNT. If the energy gain of electron is in the range of 10 meV to 100 meV, a sufficient effect can be expected. This means that there is an effect even if the laser output is very low.

Although the present invention has been described with reference to the foregoing embodiments, it is apparent for those skilled in the art that the present invention is not limited to the foregoing embodiments and that various modifications and alternation are possible without departing from the scope and spirit of the present invention. Typically the carbon nanotube may be SWNT or MWNT and may be used as a single piece or a pluraty of pieces of CNTs like a bundle of CNTs or unidirectionarily aligned CNTs, e.g., unidirectionarily grown layer of CNTs on a substrate such as SiC etc.

The meritorious effects of the present invention are summarized as follows.

As mentioned above, in accordance with the present invention the efficiency of the emission of the electrons from a cathode including carbon nanotube or nanotubes as an electron emitting material can be enhanced.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A field emitting apparatus comprising
a cathode provided with at least one carbon nanotube as an electron emitting material, and
means for irradiating said at least one carbon nanotube with light.

2. A field emitting apparatus as defined in claim 1, wherein said apparatus further comprises a polarizer for polarizing said light to irradiate said carbon nanotube(s) with said light having an electric field oriented along a longitudinal axial direction of said carbon nanotube(s).

3. A field emitting apparatus as defined in claim 2, wherein said polarizer comprises a thin film having an an isotropy in electric conductivity, said thin film having an electric conductivity along the longitudinal axial direction of said carbon nanotube (s) in place of said thin film and having no electric conductivity along a direction normal to said longitudinal axial direction, said thin film being irradiated with said light for polarizing said light.

4. A field emitting apparatus as defined in claim 1, wherein said light comprises infrared light.

5. A field emitting apparatus as defined in claim 1, wherein said light comprises laser light.

6. A field emitting apparatus as defined in claim 5, wherein said at least one carbon nanotube has a length which is about a half of a spot area of said laser light.

7. A field emitting apparatus comprising:
a bar-like elongated electrically conductive member having a length approximately of ⅓ to ¾ of a wave length of an electromagnetic wave to be irradiated on a cathode as an electron emitting material,
wherein an electric field of said electromagnetic wave to be irradiated on said electrically conductive member is oriented along a longitudinal axial direction of said electrically conductive member, and electrons are emitted from one end of said cathode.

8. A field emitting apparatus as defined in claim 7, wherein said apparatus comprises an antenna for orienting the electric field of said electromagnetic wave along a longitudinal axial direction of said electrically conductive member, said antenna comprising a plurality of electrically conductive rods extending along a longitudinal axial direction of said elongated electrically conductive member, said rods being disposed in a parallel manner in a plane which is perpendicular to the longitudinal axial direction of said elongated electrically conductive member.

9. A display device comprising:
a field emitting apparatus as defined in claim 1, and
an anode disposed in a spaced relationship with said cathode,
wherein light is emitted from a fluorescent material by applying to said anode a voltage which is positive with respect to said cathode for impinging electrons emitted from said anode to said fluorescent material.

10. A method for field emitting electrons comprising:
applying an electric field to said cathode,
providing a cathode provided with at least one carbon nanotube, and
irradiating said carbon nanotubes with light for enhancing emission efficiency of electrons.

11. A field emission method as defined in claim 10, wherein said light irradiating said carbon nanotubes has an electric field which is parallel with a longitudinal axial direction of said carbon nanotube(s).

12. A field emission method as defined in claim 10, wherein said light comprises infrared light.

13. A field emission method as defined in claim 10, wherein said light comprises laser light.

14. A field emission method as defined in claim 13, wherein said carbon nanotubes have a length which is about a half of that of a spot area of said laser light.

15. A field emission method, wherein comprising:
providing a cathode comprising a bar-like electrically conductive member having a length which is about ⅓ to about ¾ of wave length of an irradiating electromagnetic wave,
emitting electrons by applying an electric field to said cathode,
wherein the electric field of said electromagnetic wave irradiating said electrically conductive member is aligned along a longitudinal axial direction of said electrically conductive member.

16. A field emitting apparatus comprising:
a cathode provided with at least one carbon nanotube as an electron emitting material,
means for irradiating said at least one carbon nanotube with light, and means for accelerating electrons emitted from the cathode along said at least one carbon nanotube.

17. A method for field emitting electrons comprising:
applying an electric field to said cathode,
providing a cathode provided with at least one carbon nanotube,
irradiating said carbon nanotubes with light for enhancing emission efficiency of electrons, and accelerating electrons emitted from the cathode along said at least one carbon nanotube.
